(19) United States
(12) Patent Application Publication
(10) Pub. No.: US 2017/0322799 A1
(43) Pub. Date: Nov. 9, 2017

(54) VIEWING SECTION LEVEL CHANGESETS BY TIMESTAMP IN AN INTEGRATED DEVELOPMENT ENVIRONMENT

(71) Applicant: International Business Machines Corporation, Armonk, NY (US)

(72) Inventors: Joel Duquene, Raleigh, NC (US); Morris S. Johnson, JR., Cary, NC (US); Henri F. Meli, Morrisville, NC (US); Tintin S. Soemargono, Cary, NC (US); Stefanus Wiguna, Cary, NC (US)

(21) Appl. No.: 15/147,144

(22) Filed: May 5, 2016

(51) Int. Cl. G06F 9/44

(52) U.S. Cl. CPC G06F 8/71

(57) ABSTRACT

In an approach to section level version control, a computing device fetches one or more changesets associated with a section of code to generate a change history. The computing device displays the change history. The computing device displays markers to identify changes to the section of code. The computing device sorts the change history by timestamp. The computing device displays a virtual preview of a prospective change to the section of code.

### TECHNICAL FIELD OF THE INVENTION

The present disclosure relates generally to the field of software development, and more particularly to management tools for software development.

### BACKGROUND OF THE INVENTION

Changes to a software component can involve changes to multiple modules over a period of time. Keeping track of code changes is not an easy task, especially when: (i) multiple changes are involved, (ii) a new developer is viewing previous changes, and/or (iii) a developer who previously made changes has spent some time away from the changes.

Conventional source management tools allow the developer to version changes and view change history.

### SUMMARY

According to one embodiment of the present invention, a computer-implemented method, a computer program product, and/or a computer system for section level version control is provided. A computing device fetches changesets associated with a section of code to generate a change history. The computing device displays the change history. The computing device displays markers to identify changes to the section of code. The computing device sorts the change history by timestamp. The computing device displays a virtual preview of a prospective change to the section of code.

### BRIEF DESCRIPTION OF THE DRAWINGS

FIG. 1A is a block diagram of an exemplary computing environment, in accordance with an embodiment of the present invention;

FIG. 1B shows components of a section level version control program, in accordance with an embodiment of the present invention;

FIG. 2 is a flowchart depicting steps of a section level version control method, in accordance with an embodiment of the present invention;

FIG. 3 is a diagram illustrating a flow of changes made to a file, in accordance with an embodiment of the present invention;

FIG. 4 is a screen view showing a user interface for version control, in accordance with conventional technology; and

FIG. 5 is a block diagram of components of the computing device in FIG. 1 executing a section level version control program, in accordance with an embodiment of the present invention.

### DETAILED DESCRIPTION

Embodiments described herein provide methods, computer program products, and/or computer systems that enable software developers (or simply “developers,” or “users”) to view code changes at the section level, or code fragment level, over time within an integrated development environment.

Embodiments of the present invention may recognize one or more of the following facts, potential problems and/or potential areas for improvement with respect to the current state of the art: (i) developers face challenges in terms of viewing code changes in the proper context; (ii) a list of changes, in which the changes are viewed one at a time, can be insufficient and confusing; (iii) many changes may have been made in one changeset and over a period of time; (iv) looking at a list of changes made on a particular date is not sufficient to gain a complete picture; and/or (v) because multiple changes may have been made at different times, merely comparing two versions of the changes is also not ideal because it requires opening and closing multiple windows in order to attempt to keep track of a set of changes in relation to other changes that were made at different times and on different dates.

Embodiments of the present invention may further recognize one or more of the following possible scenarios, given the current state of the art: (i) if a developer updates several files, does not review the files for a number of days, and then returns to the project, it can take time for him or her to remember what was updated; (ii) if a developer is assigned to an ongoing project and needs to understand the project code as quickly as possible, he or she may need to see how a particular component or function evolved over time, or he or she may need to debug a defect without knowing what changes were made most recently, and so he or she may waste time opening and comparing multiple file versions in order to understand the evolution of the component or function; and/or (iii) if a developer discovers, after accepting a large number of changes to a code repository, that a program is not working, and if the developer does not remember which files were accepted, the developer may have difficulty determining the source of the problem and may need to ask his or her team members who have not yet accepted the changes to compare the relevant files one by one in order to identify the problematic change.

Embodiments of the present invention may include one or more of the following features, characteristics, and/or advantages: (i) a developer can easily see what has been changed and when across multiple files and across projects; (ii) a developer does not need to know firsthand which files to open in order to see what changes were recently made; (iii) a developer can view the evolution of a section of code quickly and within the file, without having to know first which versions of the file contain changes for that section; (iv) a developer has a more efficient and effective way to view changesets on section levels; and/or (v) a developer can increase productivity and understand code more quickly.

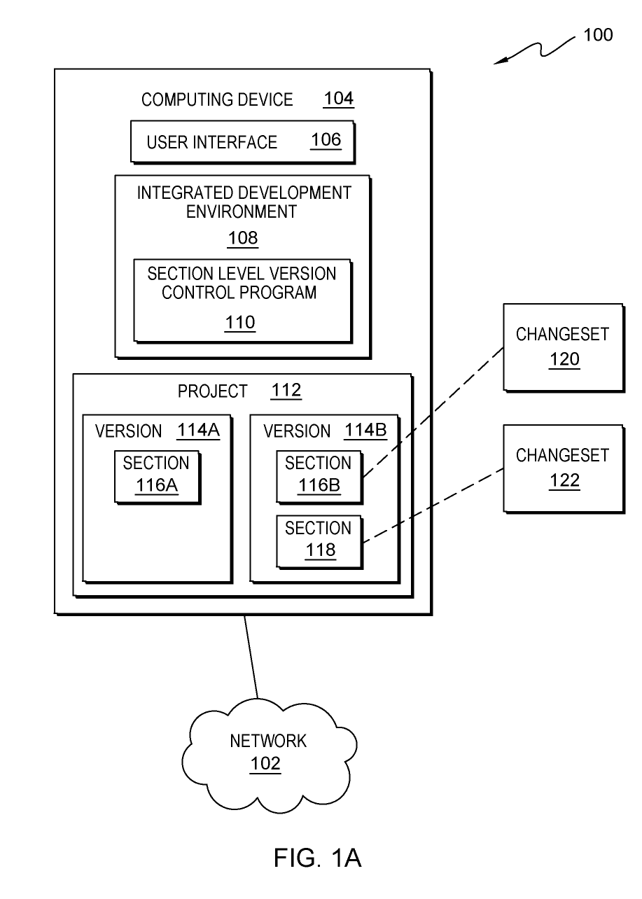

Embodiments of the present invention are described herein with reference to the Figures. FIG. 1A shows a block diagram of a computing environment 100, in accordance with an embodiment of the present invention. FIG. 1 is provided for the purposes of illustration and does not imply any limitations with regard to the environments in which different embodiments can be implemented. Many modifications to the depicted environment can be made by those skilled in the art without departing from the scope of the invention as recited in the claims.

Computing environment 100 includes computing device 104, which may be interconnected with other devices (not shown) over network 102. Network 102 may be, for example, a telecommunications network, a local area network (LAN), a wide area network (WAN), such as the Internet, or a combination of these, and can include wired, wireless, or fiber optic connections. In general, network 102 may be any combination of connections and protocols that will support communications between computing device 104 and other computing devices (not shown) within computing environment 100.

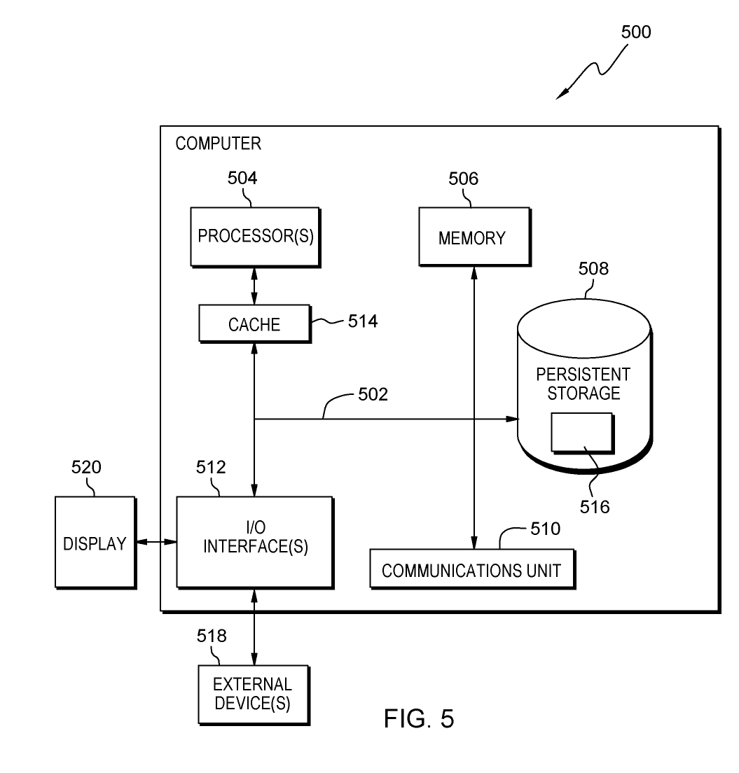

Computing device 104 may be any programmable electronic device capable of executing machine-readable instructions and communicating with other devices over network 102, in accordance with an embodiment of the present invention. Computing device 104 includes user interface 106, integrated development environment 108, section level version control program 110, and project 112. Computing device 104 may include internal and external hardware components, as depicted and described in further detail with reference to FIG. 5.

User interface 106 provides an interface between a user of computing device 104 (not shown) and computing device 104. User interface 106 may be, but is not limited to being, a graphical user interface (GUI) or a web user interface (WUI) and may display text, documents, web browser windows, user options, application interfaces, and instructions for operation, and may include the information (such as graphic, text, and sound) presented to a user and the control sequences the user employs to control section level version control program 110 (described herein).

Integrated development environment 108 provides tools for use in software development. Integrated development environment 108 may include, for example but without limitation, a source code editor, build automation tools, and a debugger. Integrated development environment 108 may include and/or operate in cooperation with section level version control program 110, which enables navigation of historical changes at a section level, as described herein with reference to FIG. 1B.

In an embodiment, project 112 may be a project comprising a plurality of file versions. Version 114A and version 114B may represent a variable number of versions, not limited to the number illustrated. Version 114A and version 114B may further comprise a plurality of sections of code (or “modules”). A section of code could be, for example but without limitation, a control block or a segment of contiguous code statements or program instructions. Section 116A, section 116B, and section 118 may represent a variable number of sections of code, not limited to the number illustrated.

Project 112 may be subject to ongoing revision (or “changes,” or “modification(s)”) by the user, illustrated as changesets 120, 122. Changesets 120, 122 represent a variable number of changesets, not limited to the number illustrated. Changesets 120, 122 may include a list of sections (e.g., section 116B) that have been modified, as well as information regarding changes made to those sections. In a non-limiting example, changeset 120 may include additions and deletions to section 116A of version 114A, producing section 116B in version 114B. In another non-limiting example, changeset 122 may include the addition of section 118 to section 114A in creating version 114B.

FIG. 1B represents components of section level version control program 110, in accordance with an embodiment of the present invention. Section level version control program 110 includes change history module (“mod”) 150, display module (“mod”) 152, marking module (“mod”) 154, sorting module (“mod”) 156, and preview module (“mod”) 158.

Mod 150 provides a change history for a sections of code, e.g., sections 116B, 118. For example, mod 150 can provide a change history for section 116B across versions, e.g., from version 114A to version 114B, by fetching changeset 120.

Mod 152 displays the change history provided by mod 150, e.g., in a side window (not shown) alongside an editor window (not shown) ordinarily provided by integrated development environment 108. In an embodiment, when providing a change history for section 116B, mod 152 can provide references to other sections of code (not shown) affected by the same changeset(s).

Mod 154 provides visual markers showing where changes have been identified by mod 150 in version 114B. For example, mod 154 may provide markers indicating that mod 150 fetched changesets comprising changes to section 116B.

In an embodiment, the user can select a marker to view a change history for a particular section. For example, the user may select a marker next to section 116B to view a change history associated with section 116B.

In an embodiment, selecting a marker can include placing a cursor over the marker.

Mod 156 enables sorting of changesets 120, 122 by timestamp. For example, changesets displayed in the side window can be collapsed to provide a list view including, e.g., a filename and a timestamp associated with each changeset. In an embodiment, mod 156 can sort changesets within one project 112 or across multiple projects.

Mod 158 provides a virtual preview of changes to section 114B. For example but without limitation, mod 158 may provide a virtual preview of the effect of adding or removing a changeset or a part of a changeset to or from section 114B.

In an embodiment, mod 158 can highlight virtually previewed changes to facilitate their identification.

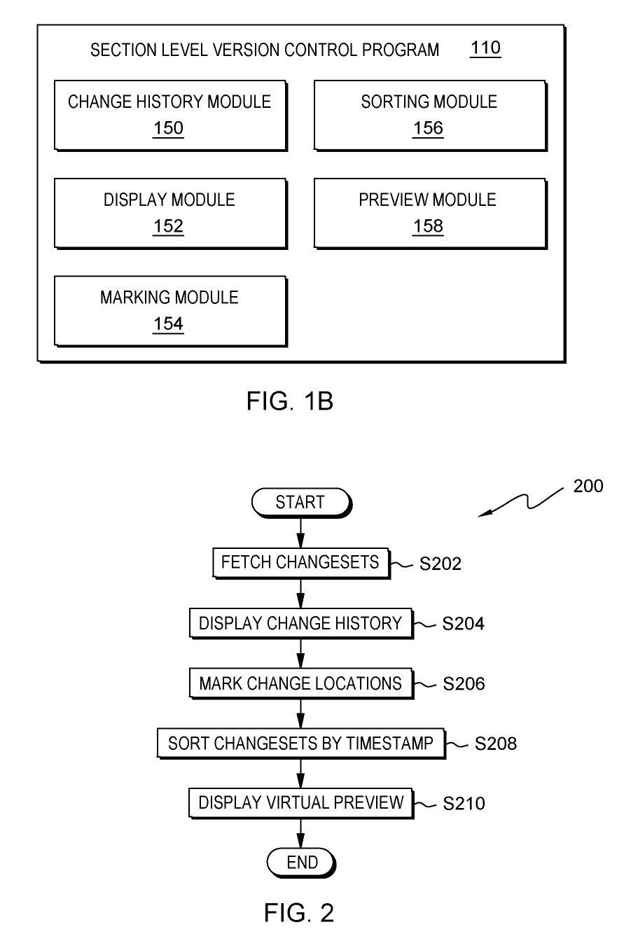

FIG. 2 is a flowchart 200 depicting operations of a section level version control method, in accordance with an embodiment of the present invention.

In operation S202, responsive to a request from a user, mod 150 generates a change history by fetching changeset 120 and additional changesets (not shown) associated with section 116B.

In operation S204, mod 152 displays the change history for section 116B based on the fetched changeset 120 and additional changesets.

In operation S206, mod 154 provides visual markers to identify where changes to section 116B have been made across versions 114A-B.

In operation S208, responsive to receiving a request from the user, mod 156 sorts changeset 120 and the additional changesets by timestamp.

In operation S210, responsive to receiving a request from the user, mod 158 displays a virtual preview of a prospective change, such as but not limited to removal and/or reapplication of changeset 120 from or to section 116B.

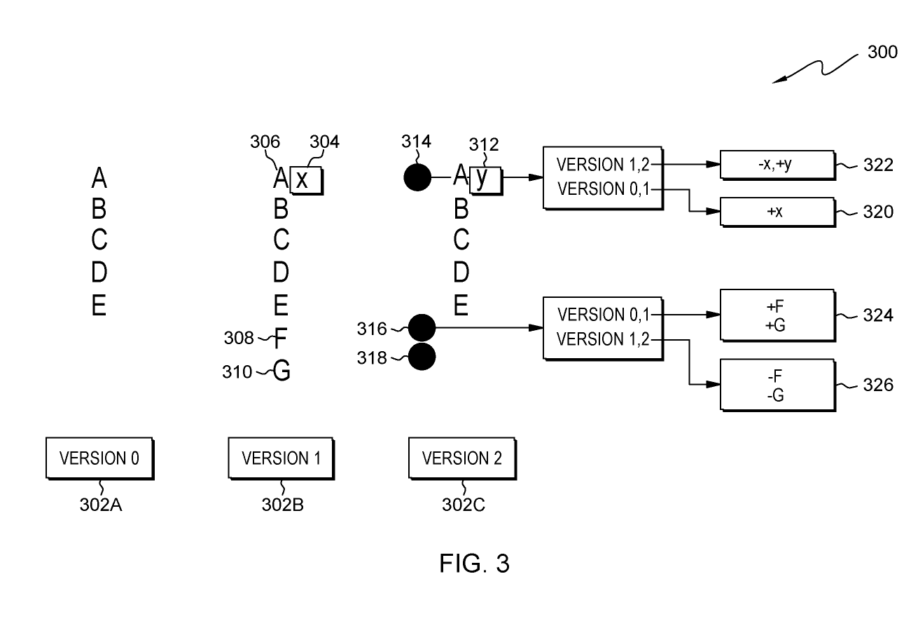

FIG. 3 is a diagram 300 illustrating a flow of changes made to a version (i.e., file) 302A, in accordance with an embodiment of the present invention. Version 302A in diagram 300 may represent version 114A in computing environment 100, modules of version 302A (e.g., section 306, described herein) may represent modules of version 114A (e.g., section 116A), and so forth; however, numbering begins at 300 in this example in the interest of clarity.

In diagram 300, version 302A represents an original file. Version 302B represents a first modified version of version 302A, wherein addition 304 to section 306 (addition ‘x’ to section ‘A’), section 308 (section ‘F’), and section 310 (section ‘G’) have been added to version 302A. Version 302C represents a second modified version of file 302A, wherein addition 312 to section 306 (addition ‘y’ to section ‘A’) has been added to version 302B, and addition 304, section 308, and section 310 have been removed from version 302B.

A user (not shown) has opened version 302C and requested to see a change history for version 302C. Responsive to the request, section level version control program 110 displays markers 314-318 to indicate where changes have been made to various sections in versions 302A-C. The user can select a marker 314-318 to view changes to sections 306, 308, and 310, respectively.

Responsive to the user selecting marker 314, section level version control program 110 displays options to view changes made to section 306 between version 302A (version ‘0’) and version 302B (version ‘1’), and between version 302B (version ‘1’) and version 302C (‘2’), respectively. For example, the user can view change 320, where addition 304 was made to section 306, and change 322, where addition 304 was removed from section 306 and addition 312 was made to section 306.

Responsive to the user selecting marker 316 or marker 318, section level version control program 110 displays options to view changes made to section 308 between version 302A and version 302B, and between version 302B and version 302C, respectively. For example, the user can view change 322, where sections 308, 310 were added to version 302A, and change 324, where sections 308, 310 were removed from version 302B.

In an embodiment, section level version control program 110 can provide options to preview a version 302D (not shown) that might result if, e.g., change 324 was reapplied to version 302C.

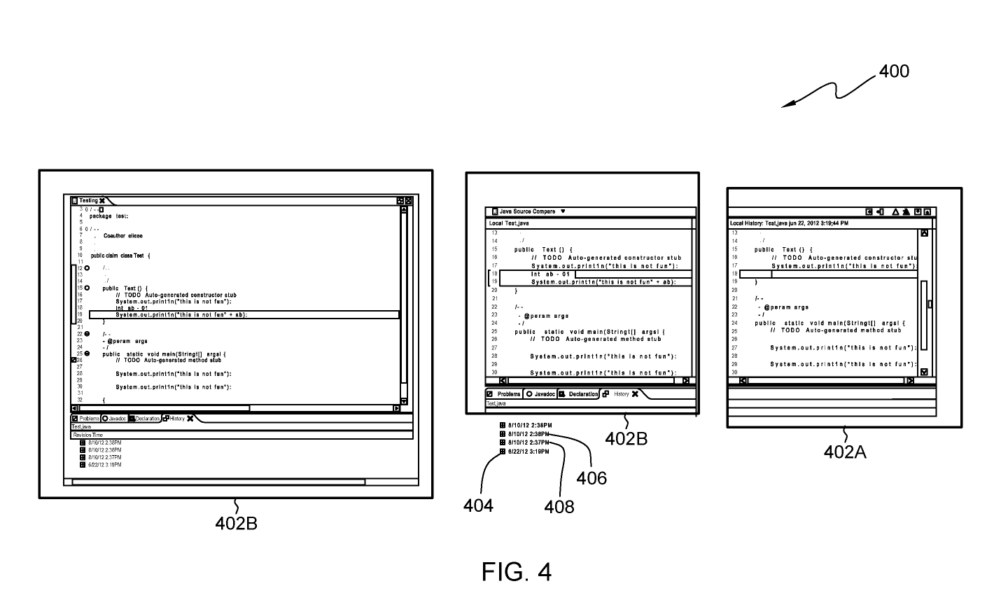

FIG. 4 is a screen view 400 showing a user interface for version control, in accordance with conventional technology. Screen view 400 shows a file version 402B as of Aug. 10, 2012. A user clicking on revision time 404 can view version 402A as of Jun. 22, 2012 and version 402B side-by-side. However, the user cannot view a history of changes occurring in intermediate versions without clicking on revision time 406 and revision time 408.

FIG. 5 depicts a block diagram 500 of components of computing device 104 in computing environment 100, in accordance with illustrative embodiments of the present invention. It should be appreciated that FIG. 5 provides only an illustration of one implementation and does not imply any limitations with regard to the environments in which different embodiments may be implemented. Many modifications to the depicted environment may be made.

Computing device 104 includes communications fabric 502, which provides communications between computer processor(s) 504, memory 506, persistent storage 508, communications unit 510, and input/output (I/O) interface(s) 512, and cache 514. Communications fabric 502 can be implemented with any architecture designed for passing data and/or control information between processors (such as microprocessors, communications and network processors, etc.), system memory, peripheral devices, and any other hardware components within a system. For example, communications fabric 502 can be implemented with one or more buses.

Memory 506 and persistent storage 508 are computer readable storage media. In this embodiment, memory 506 includes random access memory (RAM) and cache memory 514. In general, memory 506 can include any suitable volatile or non-volatile computer readable storage media. Cache 514 is a fast memory that enhances the performance of computer processor(s) 504 by holding recently accessed data, and data near accessed data, from memory 506.

Program instructions and data used to practice embodiments of the invention, referred to collectively as component(s) 516, are stored in persistent storage 508 for execution and/or access by one or more of the respective computer processors 504 via one or more memories of memory 506. In this embodiment, persistent storage 508 includes a magnetic hard disk drive. Alternatively, or in addition to a magnetic hard disk drive, persistent storage 508 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 508 may also be removable. For example, a removable hard drive can be used for persistent storage 508. Other examples include optical and magnetic disks, thumb drives, and smart cards that are inserted into a drive for transfer onto another computer readable storage medium that is also part of persistent storage 508.

Communications unit 510, in these examples, provides for communications with other data processing systems or devices. Communications unit 510 can include one or more network interface cards. Communications unit 510 can provide communications through the use of either or both physical and wireless communications links. Component(s) 516 can be downloaded to persistent storage 508 through communications unit 510.

I/O interface(s) 512 allows for input and output of data with other devices that may be connected to computing device 104. For example, I/O interface 512 can provide a connection to external devices 518 such as a keyboard, keypad, a touch screen, and/or some other suitable input device. External devices 518 can also include portable computer readable storage media such as, for example, thumb drives, portable optical or magnetic disks, and memory cards. Software and data used to practice embodiments of the present invention, e.g., component(s) 516, can be stored on such portable computer readable storage media and can be loaded onto persistent storage 508 via I/O interface(s) 512. I/O interface(s) 512 also connect to a display 520.

Display 520 provides a mechanism to display data to a user and may be, for example, a touchscreen.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method for section level version control, the method comprising:
fetching, by one or more computer processors, changesets associated with a section of code to generate a change history;
displaying, by one or more computer processors, the change history;
displaying, by one or more computer processors, markers to identify changes to the section of code;
sorting, by one or more computer processors, the change history by timestamp; and
displaying, by one or more computer processors, a virtual preview of a prospective change to the section of code.

2. The computer-implemented method of claim 1, wherein the change history is displayed in a side window alongside an editor window in which the section of code is displayed.

3. The computer-implemented method of claim 1, wherein the change history comprises references to other sections of code affected by the changesets.

4. The computer-implemented method of claim 1, wherein the markers can be selected to display changes associated with the markers.

5. The computer-implemented method of claim 1, wherein sorting the change history by timestamp further comprises:
displaying, by one or more computer processors, a list view of changesets associated with the section of code.

6. The computer-implemented method of claim 1, wherein displaying a virtual preview of a prospective change to the section of code further comprises:
displaying, by one or more computer processors, a virtual preview of the effect of removing one or more additions to or deletions from the section of code made in one or more of the changesets.

7. The computer-implemented method of claim 6, further comprising:
highlighting, by one or more computer processors, one or more resulting changes to the section of code.

8. A computer program product for section level version control, the computer program product comprising:
one or more computer readable storage media and program instructions stored on the one or more computer readable storage media, the program instructions comprising:
program instructions to fetch changesets associated with a section of code to generate a change history;
program instructions to display the change history;
program instructions to display markers to identify changes to the section of code;
program instructions to sort the change history by timestamp; and
program instructions to display a virtual preview of a prospective change to the section of code.

9. The computer program product of claim 8, wherein the change history is displayed in a side window alongside an editor window in which the section of code is displayed.

10. The computer program product of claim 8, wherein the change history comprises references to other sections of code affected by the changesets.

11. The computer program product of claim 8, wherein the markers can be selected to display changes associated with the markers.

12. The computer program product of claim 8, wherein program instructions to sort the change history by timestamp further comprise:
program instructions to display a list view of changesets associated with the section of code.

13. The computer program product of claim 8, wherein program instructions to display a virtual preview of a prospective change to the section of code further comprise:
program instructions to display a virtual preview of the effect of removing one or more additions to or deletions from the section of code made in one or more of the changesets.

14. The computer program product of claim 13, further comprising:
program instructions to highlight one or more resulting changes to the section of code.

15. A computer system for section level version control, the computer system comprising:
one or more processors;
one or more computer readable storage media; and
program instructions stored on the one or more computer readable storage media for execution by at least one of the one or more processors, the program instructions comprising:
program instructions to fetch changesets associated with a section of code to generate a change history;
program instructions to display the change history;
program instructions to display markers to identify changes to the section of code;
program instructions to sort the change history by timestamp; and
program instructions to display a virtual preview of a prospective change to the section of code.

16. The computer system of claim 15, wherein the change history is displayed in a side window alongside an editor window in which the section of code is displayed.

17. The computer system of claim 15, wherein the change history comprises references to other sections of code affected by the changesets.

18. The computer system of claim 15, wherein the markers can be selected to display changes associated with the markers.

19. The computer system of claim 15, wherein program instructions to sort the change history by timestamp further comprise:
program instructions to display a list view of changesets associated with the section of code.

20. The computer system of claim 15, wherein program instructions to display a virtual preview of a prospective change to the section of code further comprise:
program instructions to display a virtual preview of the effect of removing one or more additions to or deletions from the section of code made in one or more of the changesets.
